(19) United States
(12) Patent Application Publication
(10) Pub. No.: US 2025/0251929 A1
(43) Pub. Date: Aug. 7, 2025

(54) STORAGE MANAGEMENT FOR ONLINE SOFTWARE DEVELOPMENT AND HOSTING

(71) Applicant: Replit, Inc., San Francisco, CA (US)

(72) Inventors: Luis Hector Chavez Freire, Mountain View, CA (US); Zach Anderson, San Francisco, CA (US)

(21) Appl. No.: 18/431,962

(22) Filed: Feb. 3, 2024

(51) Int. Cl. G06F 8/71

(52) U.S. Cl. CPC G06F 8/71

(57) ABSTRACT

Techniques for storing, serving and persisting data for online software development and hosting that use the principles of copy-on-write modification to reduce the amount of storage space needed to store data, reduce the processing time to serve data, and persist data to remote storage in a way that minimizes the risk of data corruption.

### BACKGROUND

Software development often requires developing or creating software programs in the form of computer code that can be very lengthy and complex. As such, creating and understanding a computer program can be difficult, particularly for novice programmers, or for programmers trying to use a mobile device for programming. Computer programmers write, modify, and test code and scripts that allow computer software and applications to function properly.

An integrated development environment (IDE) is a software application that provides comprehensive facilities for software development (e.g., a source-code editor, a code package manager, a debugger, and other programming tools). An online integrated development environment, also known as a “web IDE” or “cloud IDE”, is a browser-based IDE that can be accessed by a client device via a network using web browser (e.g., Firefox, Google Chrome or Microsoft Edge), enabling software development on a client device using features provided by the network devices of the online integrated development environment.

### SUMMARY

Disclosed are techniques for storing, serving and persisting data for online software development and hosting. The disclosed techniques use the principles of copy-on-write modification to reduce the amount of storage space needed to store data, reduce the processing time to serve data, and persist data to remote storage in a way that minimizes the risk of data corruption.

### BRIEF DESCRIPTION OF THE DRAWINGS

For a detailed description of various examples, reference will now be made to the accompanying drawings in which:

FIG. 1 shows an example network environment in which embodiments described herein may be performed, in accordance with one or more embodiments;

FIG. 2 shows a diagram illustrating prior art storage management for an online integrated development environment;

FIG. 3 shows a diagram of a storage management process for an online integrated development environment, according to an exemplary embodiment;

FIGS. 4A and 4B show a flowchart of a technique for copy-on-write modifying data blocks, according to one or more embodiments;

FIG. 5 shows a flowchart of a technique for forking a project instance, according to one or more embodiments;

FIG. 6 shows a flowchart of another technique for copy-on-write modifying data blocks, according to one or more additional embodiments;

FIG. 7 shows a flowchart of a technique for reducing storage space, according to one or more additional embodiments;

FIG. 8 shows a flowchart of a technique for serving a project instance, according to one or more additional embodiments;

FIG. 9 shows a flowchart of a technique for persisting a project instance to remote storage, according to one or more additional embodiments; and

FIG. 10 shows an example of a hardware system for implementation of the storage management techniques in accordance with the disclosed embodiments.

### DETAILED DESCRIPTION

The following description relates to improved techniques for storing, serving and persisting data by an online integrated development environment. The disclosed techniques use the principles of copy-on-write modification to reduce the amount of storage space needed to store data, reduce the processing time to serve data, and persist data to remote storage in a way that minimizes the risk of data corruption.

In the following description, numerous specific details are set forth to provide a thorough understanding of the various techniques. As part of this description, some of the drawings represent structures and devices in block diagram form. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flow diagram may be presented in a particular order. However, it should be understood that the particular flow of any flow diagram is used only to exemplify one embodiment. In other embodiments, any of the various components depicted in the flow diagram may be omitted, or the components may be performed in a different order, or even concurrently. In addition, other embodiments may include additional steps not depicted as part of the flow diagram. Further, the various steps may be described as being performed by particular modules or components. It should be understood that the language used in this disclosure has been principally selected for readability and instructional purposes, and may not have been selected to delineate or circumscribe the disclosed subject matter. As such, the various processes may be performed by alternate components than the ones described.

Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

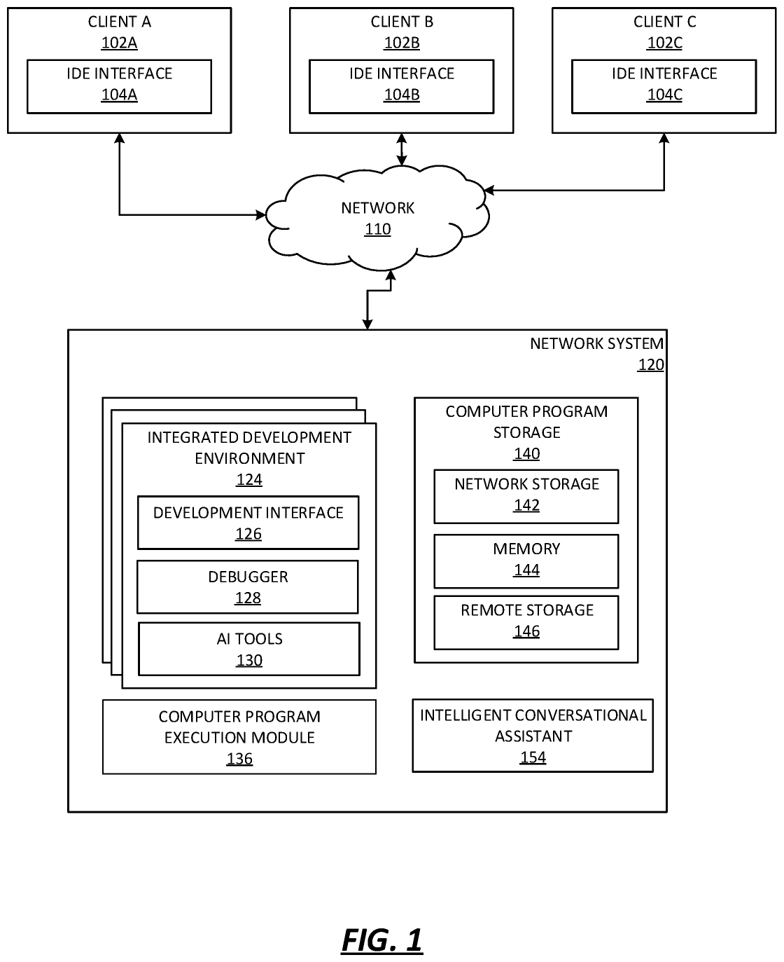

FIG. 1 shows a network diagram of an environment in which various embodiments described herein may be practiced. The network diagram includes multiple client devices, such as client A 102A, client B 102B, and client C 102C, communicably connected to a network system 120 across a network 110. Although a particular representation of components and modules is presented, it should be understood that in some embodiments, the various components and modules may be differently distributed among the devices pictured, or across additional devices not shown.

Clients 102A, 102B, and 102C may each be computing devices from which an integrated development environment (IDE) 124 is accessed. An IDE 124 is computer software that provides tools used by programmers to develop software (referred to herein as a “project instance”). The IDE 124 may include, for example, a source code editor, code package manager, debugger, and other programming tools. The IDE 124 may be hosted on one or more network devices of network system 120. The IDE 124 may be accessed across the network 110 via an IDE interface from each client, such as IDE interface 104A, IDE interface 104B, and IDE interface 104C. The IDE interface 124 may be an application running on the corresponding client device, or may be accessed from a remote device such as a network device via a web browser, or the like.

The IDE 124 hosted on network system 120 may include a development interface 126, which may provide a source code editor for a computer program which is the focus of a development session by one or more programmers on the client devices 102A, 102B, and 102C. The computer program may be written in any known computer programming language. The IDE 124 may additionally include a debugger 128. Debugger 128 is a program that facilitates the detection and correction of errors in other computer programs. In addition, the debugger 128 can be used as a tool to track the operation of other computer programs. To that end, the debugger 128 may be a program which provides a capability to monitor the execution of a program, stop the program, start the program, set breakpoints, set and read values, and the like. The debugger 128 includes logic such that it is capable of communicating with the operation system to cause the program to perform debugging actions, such as pause, continue, modify, inspect memory, and the like.

According to some embodiments, the IDE 124 may include artificial intelligence (AI) tools 130, which may include one or more networks or models which are trained to assist in code development. As described in detail in U.S. patent application Ser. No. 18/179,551, for example, the AI tools 130 a code completion network, a code generation network, a code explanation network, and a code transformation network.

As described in detail below, network system 120 stores computer programs developed using the IDE 124 in computer program storage 140. The computer program storage may include network storage 142, memory 144, and/or remote storage 146. This computer program storage 140 may be a storage space provided on a per account basis. For example, an account may be associated with an individual developer (e.g., user) developing the computer program, or the account may be an organizational account associated with an organization, such as a company, corporation, etc., with multiple developers' (e.g., users') sub-accounts associated with the organizational account developing the computer program. In some cases, multiple computer programs may be associated with a single account. Code specific for the computer program, along with other data for the computer program (e.g., images, data files, etc.), may be stored in the computer program storage 140, and the computer program storage 140 may be allotted a certain amount of available storage, for example, based on a status, service tier, type, etc. of the account. In some cases, the computer program storage 140 may be a part of a container, such as a Docker container (Docker is a registered trademark of Docker, Inc.), or part of a virtual machine image. The remote storage 146 may be hosted, for example, on a cloud service accessible via the network 110, such as Google Cloud Platform (Google is a registered trademark of Google LLC), Amazon Web Services (Amazon Web Services is a registered trademark of Amazon Technologies, Inc.), etc.

The network system 120 also includes a computer program execution module 136. While shown in this example as a separate module, it should be understood that in some cases, the computer program execution module 136 may be integrated with other components, such as the IDE 124. The computer program execution module 136 prepares and executes the computer program. For example, a developer of a computer program may cause the computer program to be executed from the IDE 124. The computer program execution module 136 may prepare the source code for execution by performing, for example, code linking, compilation, interpreting, binding, etc. prior to executing the computer program.

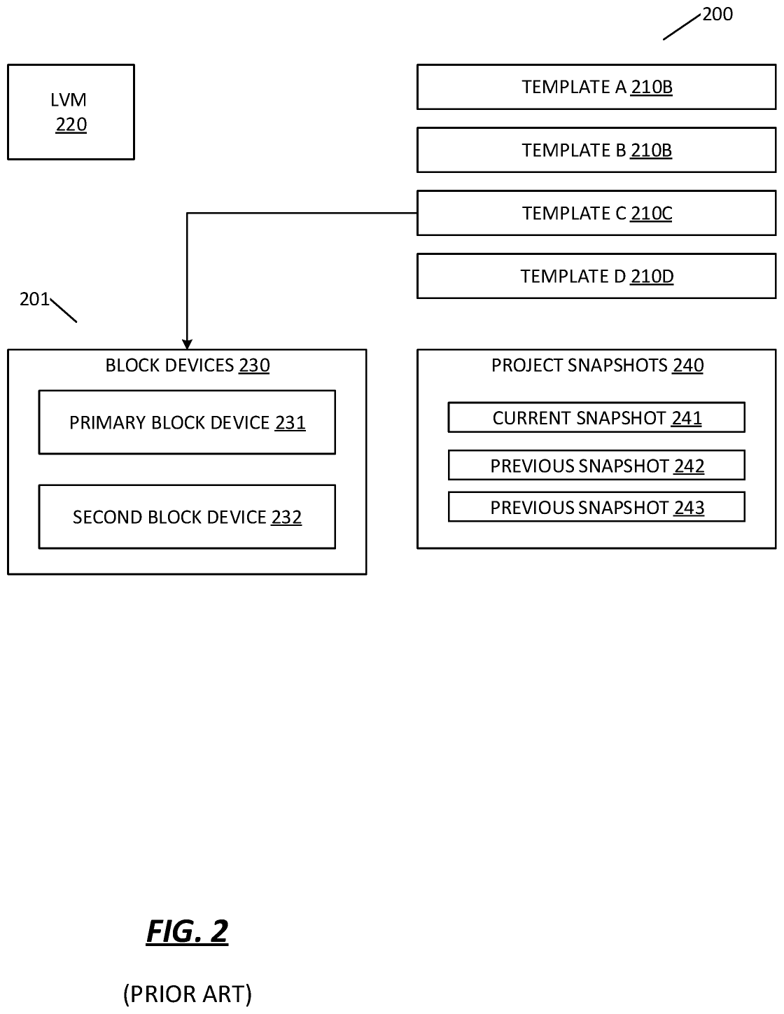

FIG. 2 shows a block diagram illustrating prior art storage management 200 for an online integrated development environment.

As shown in FIG. 2, the online integrated development environment provides functionality for users to create project instances 201 and write code. For each new project instance 201, a logical volume manager (LVM) 220 creates one or more virtual block devices 230. The project instance 201 then uses a filesystem to control how data is stored and retrieved. In the example of FIG. 2, for instance, the logical volume manager 220 creates a primary block device 231 for use by the filesystem of the project instance 201 and a second virtual block device 232 for other directories that are writable by the project instance 201 (e.g., temporary storage, etc.).

The filesystem indexes all the data for the project instance 201. In the example of FIG. 2, the filesystem uses the btrfs format, a copy-on-write (COW) filesystem that indexes files as serialized snapshots 240 using btrees. When using a btrfs filesystem, every time there is a change to data, the system creates a copy of that data (and all the btrees that reference it), writes all the updated data structures in another region of the device, and then deletes the original data. In a btrfs format, the serialized snapshots 240 include the current snapshot 241 of the filesystem as well as previous snapshots 242, 243, etc.

To create the new project instance 201, the online integrated development environment copies an existing project instance 201 (for example, a template 210A, 210B, 210C, 210D, etc., provided by the online integrated development environment or a previous project instance created by the user). Specifically, once the filesystem of the new project instance 201 is mounted, the logical volume manager 220 streams a serialized version of the current snapshot 241 of the filesystem of the project instance 201 being copied (e.g., Template C of FIG. 2).

The prior art storage management process 200 illustrated in FIG. 2 has several drawbacks. First, deserializing a snapshot 240 of another project instance is a time-consuming process. Meanwhile, if there is any problem with the project instance 201, the online integrated development environment 124 may need several minutes to recover (or even several minutes to crashloop). Additionally, the prior art storage management process 200 requires a lot of processing cycles because, each time any file of a project instance 201 changes, the online integrated development environment 124 does a full snapshot 241 and saves the full serialized version to remote storage 148. Because that process gets even slower as the size of the project instances get larger, the size of each primary block device 231 may need to be capped (for example, to 1 GiB). Otherwise, the new project instance 201 would need several minutes for the filesystem to be deserialized, even with compression techniques and pooling thousands of virtual LVM devices 220.

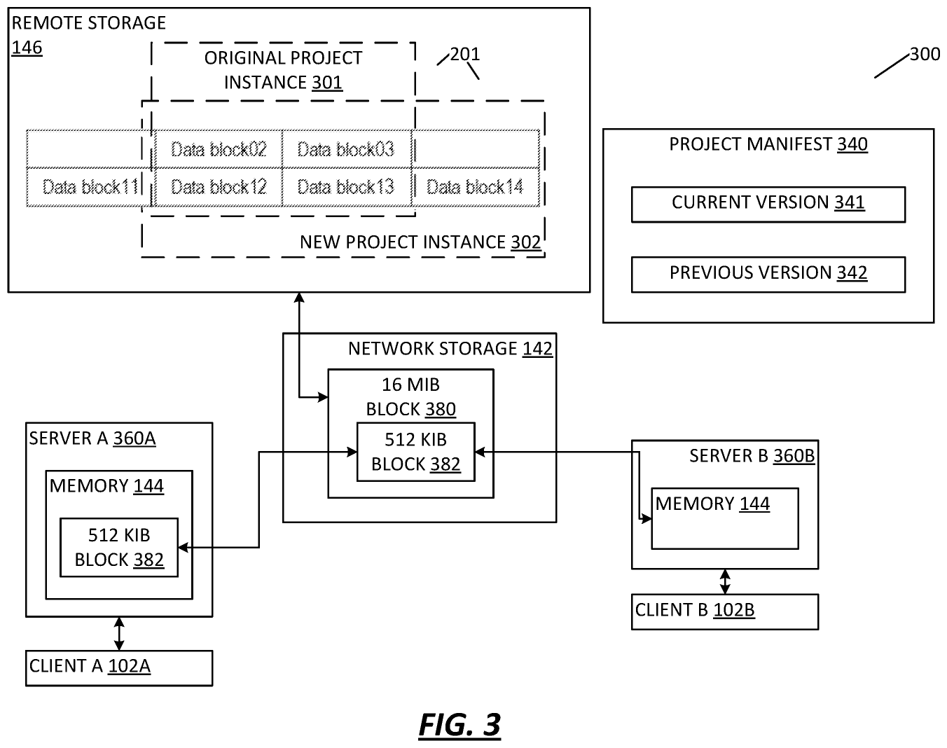

FIG. 3 shows a diagram of a storage management process 300 for an online integrated development environment, according to an exemplary embodiment. As described in detail below, the disclosed storage management process 300 uses the principles of copy-on-write to reduce processing time and allow project instance 201 to grow (e.g., to unbounded sizes) by eliminating the need to persist the entire project instance 201 all at once.

Rather than storing thousands of separate files (with their own metadata and permissions), the online integrated development environment stores project instances 201 as data blocks in remote storage 146. In the disclosed storage management process 300, each project instance 201 includes a project manifest 340 that serves as a map for each of the data blocks included in each project instance 201. Each project manifest 340 includes a mapping of disk regions to blocks stored in remote storage 146 (e.g., the offset and size of each data block), for example in a manner that is agnostic of the file or directory structure written to those disk regions.

As shown in FIG. 3, each project manifest 340 may include the current version 341 of the project instance 201 as well as one or more previous versions 342 of the project instance 201. As described above, when data blocks are copy-on-write modified, the modified data is written to new data blocks. By maintaining a previous version 342 with references to the previously used data blocks, the disclosed storage management method 300 enables users to revert to previous versions of each project instance 201, recover lost data, and debug potentially difficult-to-diagnose bugs. Additionally, the online integrated development environment can provide a read only view of a project instance 201 (for example, if someone other than the user views the project instance 201) by reading the data blocks in the manifest 340.

Unlike in the prior art, multiple project manifests 340 for multiple project instances 201 can reference the same data blocks. In the embodiment shown in FIG. 3, for example, a new project instance 302 that is forked from an original project instance 301 (e.g., a template 210) includes all of the data blocks of the original project instance 301. Additional data added to the new project instance 302 is then stored in additional data blocks (e.g., data block 14 of FIG. 3).

The disclosed storage management process 300 enables both of the project instances 301 and 302 to use the same data, while requiring the network system 120 to store only one copy of those data blocks. Additionally, disclosed storage management process 300 makes it faster to create new project instances 201 by forking existing project instances 201. To fork the original project instance 301 and create the new project instance 302 as shown in FIG. 3, for instance, all that is required is to copy the project manifest 340 for the original project instance 301 as the project manifest 340 for the new project instance 302. Because those data blocks are copy-on-write modified during the forking process (and, later, by the user of the new project instance 302), the project manifest 340 of the new project instance 302 will be identical to the manifest 140 for the original project instance 301 until that data is modified by the user of the new project instance 302.

The virtual disk in remote storage 146 is partitioned into blocks 380 (e.g., 16 MiB blocks). The blocks 380 in remote storage 146 may be compressed. In some embodiments, blocks 380 that are used less often (e.g., by a project instance 201 that has been less active) may be moved to a different cloud storage tier (e.g., a lower cost cloud storage tier with higher latency).

In addition to reducing storage space, the disclosed storage management process 300 also significantly reduces the number of processing cycles required to boot up project instances 201. As mentioned above, using the prior art btrfs snapshots 240, booting up a project instance 201 requires streaming the entire current snapshot 241 of the project instance 201 from remote storage 146 to network storage 142. Using the disclosed storage management process 300, all that is required to boot up a project instance 201 is for the client device 102 to send a connection request to a server 360A, which validates the request and establishes an NBD session with the project instance 201. To access files, the client device 102 sends requests to read sectors of the NBD disk to the server 360A. The server 360A determines which block 380 the requested sectors fall into, downloads the entire block 380 from remote storage 146, and writes the downloaded block 380 to a local cache disk (e.g., network storage 142). The server 360 may then slice the downloaded block 380 into smaller blocks 382 (e.g., 512 KiB blocks), copy one or more smaller blocks 382 to memory 144, and then serve requests directly from memory 144. By transferring blocks 380 from and to the remote storage 146, the disclosed storage management method 300 takes advantage of the fact that file systems try to group relevant data on disk, allowing the online integrated development environment to minimize the amount of time spent page faulting to a high layer of the cache and keep things moving quickly. Many project instances 201, for example, may be small enough to only require downloading one or two blocks 380 from remote storage 146 to populate their entire filesystems.

Additionally, the disclosed storage management process 300 significantly reduces the number of processing cycles required to store updated project instances 201. As described above, each time any file of a project instance 201 changes using the prior art btrfs snapshots 240, a full snapshot 240 is saved to remote storage 148. Using the disclosed storage management process 300, the project manifest 340 is updated to reference those new data blocks and only those new data blocks need to be transferred to remote storage 146. Therefore, rather than persisting a full snapshot 240 of the project instance 201 (including transferring data blocks that remained unchanged back to remote storage), the project manifest 340 simply references the data blocks that remain unchanged in remote storage 146. Because a server 360 can instantly boot and update project instances 201 regardless of the size of those project instances 201, the online integrated development environment does not need to cap the size of each project instance 201 to maintain adequate performance.

In some embodiments, the disclosed storage management process 300 may further reduce processing cycles by serving the same block 380 downloaded to network storage 142 to multiple client devices 102 running multiple project instances 201. As described above, the same data blocks may be referenced by multiple project manifests 340 of multiple project instances 201 (for example, that were forked from the same template 210). Accordingly, in some embodiments, requests to access project instances 201 referencing the same data blocks may be routed to the same server 360 to serve the same blocks 380 to multiple client devices 102 from network storage 142 (or to serve smaller blocks 382 from memory 144). Additionally or alternatively, the network storage 142 (e.g., a storage server) may be accessible to multiple servers 360. In those instances, multiple servers 360 (e.g., the server 360A and the server 360B as shown in FIG. 3) may serve the same block 380 downloaded to network storage 142 to multiple client devices 102 (e.g., the client device 102A and the client device 102B as shown in FIG. 3). Additionally, in embodiments where the network storage 142 (e.g., a storage server) is accessible to multiple servers 360, the disclosed storage management process 300 may enable multiple servers 360 to the serve the same block 380 downloaded to network storage 142 to the same client device 102 at different points in time. For example, if the server 360A serves a project instance 201 to a client device 102 and then becomes unavailable (e.g., for maintenance, upgrades, etc.), the client device 102 may be connected to the server 360B, which can access the block 380 that has already been downloaded to network storage 142.

In some embodiments, the online integrated development environment may limit the number of previous versions 342 stored for each project instance. In those instances, the online integrated development environment 200 may include a utility that scans the project manifests 340 of all of the project instances 201 and identifies the data blocks that are no longer referenced in the project manifest 340 of any project instance 201 (and can therefore be deleted). To prevent the utility from rewriting or deleting data blocks that have just been written (in the time period since the utility scanned the project manifests 340), the system may time stamp each data block to indicate when each data block is accessed by a project instance 201. In those instances, the utility may read the timestamp of those data blocks and only mark the data blocks for deletion that have not be read for a predetermined time period. For example, in an embodiment where each project instance 201 can run for only 24 hours, the utility may only mark data blocks for deletion that have not been read for 24 hours. Additionally, the online integrated development environment may keep track of when each version 341, 342 is used to create a read-only view and avoid rewriting, reusing, or deleting those data blocks.

Additionally, in some embodiments, the system may further reduce storage space by eliding the copy-on-write process for data that has not be accessed by another project instance 201. As described above, for instance, each data block may be timestamped to indicate when each data block is accessed by a project instance 201. Therefore, if a project instance 201 writes to a data block and then modifies the data stored in that data block before any other project instance 201 has read from that data block in the intervening time period, the project instance 201 may elide the copy-on-write process and instead rewrite that data block.

The disclosed storage management method also minimizes the risk of data corruption (for example, if a network connection is dropped during a filesystem write over the network 110) by detecting safe points to persist the filesystem contents to remote storage 146 and, if a network connection is dropped unexpectedly, discarding anything that was modified since the last safe point. In some embodiments, for example, the online integrated development environment may employ a userspace block device driver to detect safe points and allow the editor to know which versions of the files have been persisted to remote storage 146. In other embodiments, the system may detect when super blocks are updated. In a btrfs file system, super blocks are in-disk data structures and have pointers to the “root btrees” that hold pointers to all other btrees that store data and metadata. To update the super blocks, the write_all_supers function sends a flush request, writes the first super block with the Force Unit Access flag (FUA), and writes the rest of the super blocks. The moment after all the super blocks are updated is when the filesystem is fully consistent; all the on-disk data structures are freshly written and the pointers to these data structures are now updated in the super blocks. Since the super blocks are written to fixed locations (with fixed offsets and a fixed size of the writes), the network system 120 can easily detect every time the super blocks are updated, persist the filesystem contents to cloud storage 80 after the super blocks are updated and, if a network connection is dropped unexpectedly, discarding anything that was modified since the last safe point.

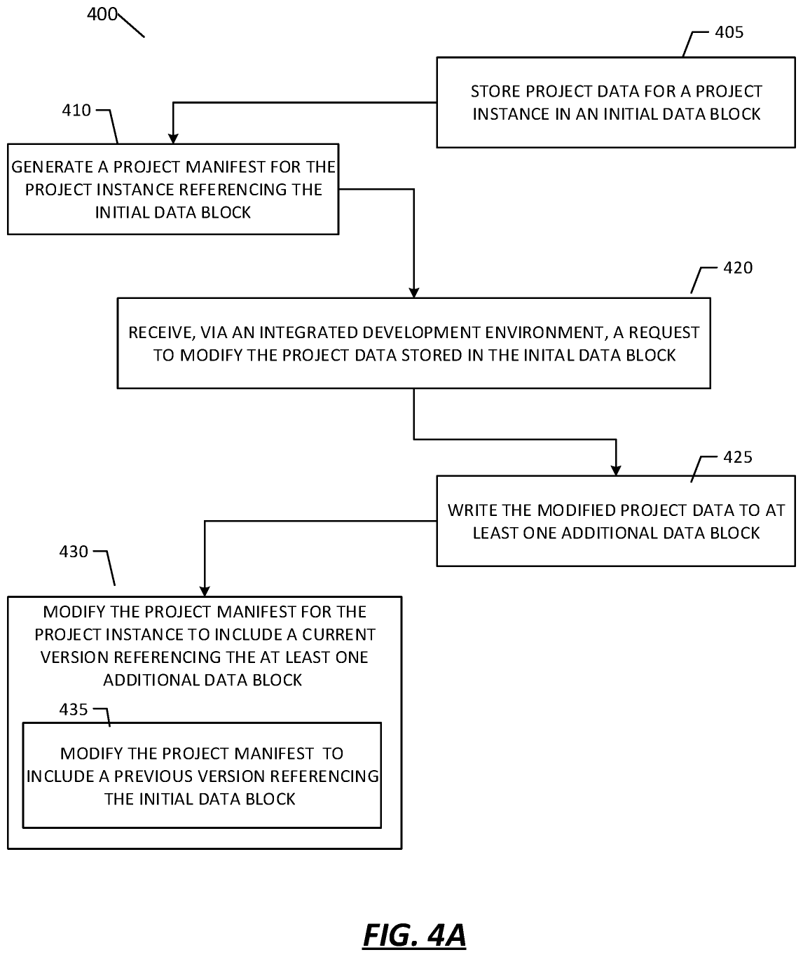

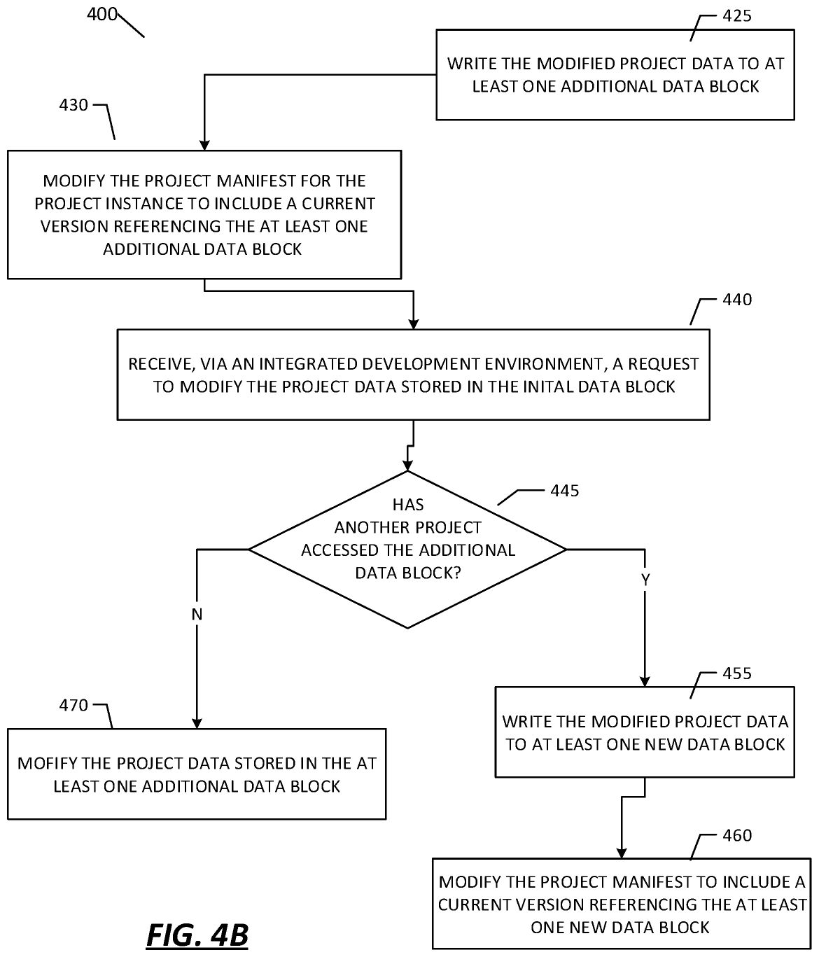

FIGS. 4A and 4B show a flowchart 400 of a technique for copy-on-write modifying data blocks, according to one or more embodiments.

The flowchart 400 begins at block 405, where the system stores project data for a project instance 201 in an initial data block. The initial data block may be located, for example, in remote storage 146, network storage 142, etc. The project data may include, for example, source code written by a user of a client device 102 via the development interface 126, data generated by software programs executed by the computer program execution module 136, data generated for the project instance 201 by the integrated development environment 124 (e.g., by the debugger 128, one of the AI tools 130, etc.), etc. The flowchart 400 continues at block 410, where a project manifest 340 is generated for the project instance 201 referencing the initial data block. At block 420, a request to modify the project data stored in the initial data block is received. Again, the request to modify the project data may be a modification of the source code made by a user via the development interface 126, a modification made by a software program executed by the computer program execution module 136, etc.

In response to the request to modify the project data at block 420, the modified project data is written to at least one additional data block at block 425. Again, the initial data block may be located, for example, in remote storage 146, network storage 142, etc.

The flowchart 400 continues at block 430, where the project manifest 340 for the project instance 201 is modified to include a current version 341 that references the at least one additional data block. As shown at block 435, in some embodiments, modifying the project manifest 340 also includes storing the reference to the initial data block as part of a previous version 342 of the project instance 201.

In some embodiments, the process continues to block 440 of FIG. 4B, where a request to modify the project data stored in the initial data block is received. In the one or more embodiments of FIG. 4B, a determination is made at block 445 as to whether another project instance 201 has accessed the data stored in the additional data block. In response to a determination at block 445 that another project instance 201 has accessed the data stored in the additional data block, the modified project data is written to at least one additional data block at block 455 the project manifest 340 for the project instance 201 is modified to include a current version 341 that references the at least one additional data block at block 460. Alternatively, in response to a determination at block 445 that another project instance 201 has not accessed the data stored in the additional data block, the copy-on-write process may be elided and the project data stored in the initial data block may be modified at block 470.

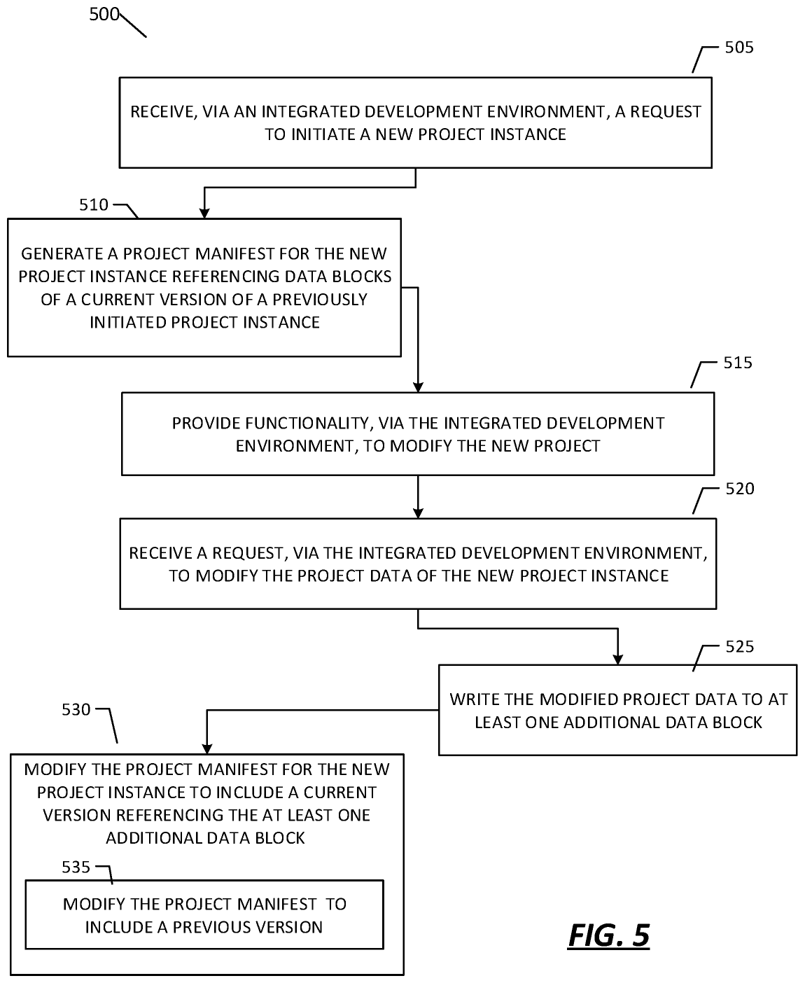

FIG. 5 shows a flowchart 500 of a technique for forking a project instance, according to one or more embodiments.

The flowchart 500 begins at block 505, where a request to initiate a new project instance 302 is received via the integrated development environment 124. In response to the request to initiate the new project instance 302 at block 505, the new project instance 302 is initiated by forking an existing project instance 301. The existing project instance 301 may be, for example, a template 210 stored by the network system 120, a previous project instance of the user, etc. As shown at block 510, in some embodiments, the previous project instance 301 is forked by copying the current version 341 of a previous project instance 301 and saving it as the project manifest 340 for the new project instance 302.

Because the new project instance 302 is forked from the previous project instance 301, the project data of the new project instance 302 is the same as the project data of the previous project instance 301. Instead of copying that project data and storing duplicate copies of that project data, the technique outlined in flowchart 500 uses the same data blocks to store the project data that is included in both the existing project instance 301 and the new project instance 302. As a result, the project manifest 340 for the new project instance 302 includes a reference to the data blocks storing the project data of the new project instance 302 and those data blocks are also referenced in the project manifest 340 of the previous project instance 301.

The flowchart 500 continues at block 515, which functionality is provided via the integrated development environment 124 to modify the new project 302. The flowchart 500 continues at blocks 520 through 535, which are similar to blocks 420 through 435 of the flowchart 400. At block 520, a request to modify the project data of the new project 302 is received. In response to the request to modify the project data at block 520, the modified project data is written to at least one additional data block at block 525. The flowchart 500 continues at block 530, where the project manifest 340 for the new project instance 302 is modified to include a current version 341 that references the at least one additional data block. As shown at block 535, in some embodiments, modifying the project manifest 340 also includes storing a previous version 342 of the new project instance 302.

As described above, the technique described in the flowchart 500 enables users to modify a new project instance 302 and modified project data in additional data blocks. However, the disclosed technique enables the network system 120 to store a single copy of project data that is common to both the new project instance 302 and the previous project instance 301 and, instead, generate project manifests 340 for both the new project instance 302 and the previous project instance 301 that reference the same data blocks.

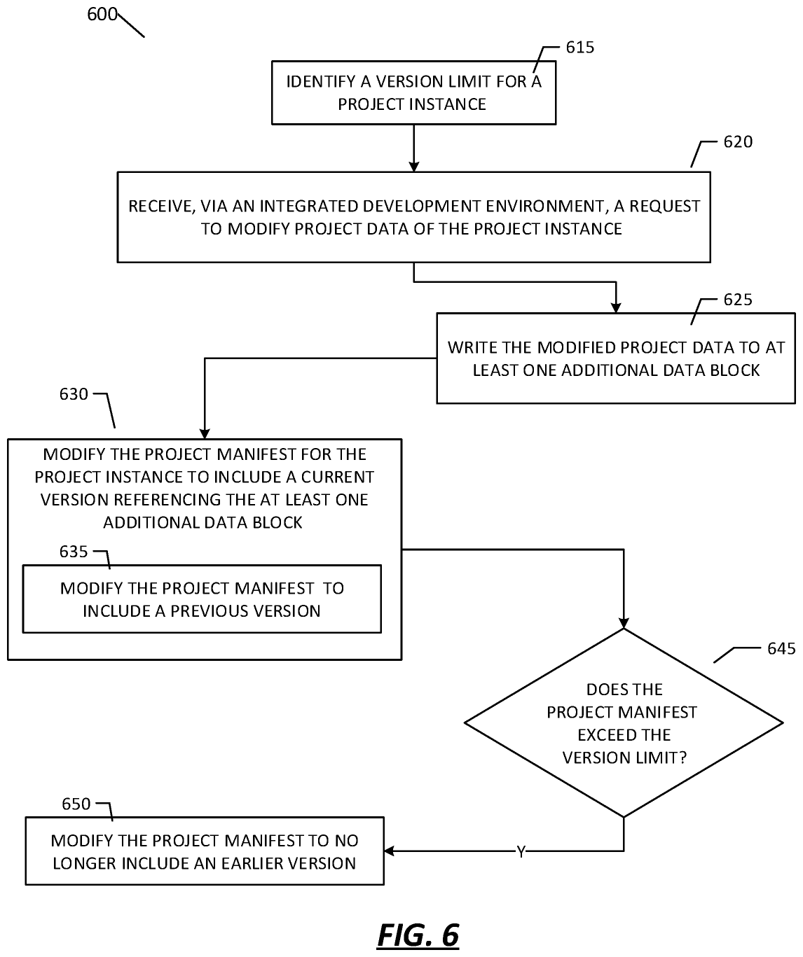

FIG. 6 shows a flowchart 600 of another technique for copy-on-write modifying data blocks, according to one or more additional embodiments.

The flowchart 600 begins at block 615, where a limit on the number of versions 342 of a project instance 201 that will be stored is identified. The flowchart 600 continues at blocks 620 through 635, which are similar to blocks 420 through 435 of the flowchart 400. At block 620, a request to modify the project data of the project instance 201 is received. In response to the request to modify the project data at block 620, the modified project data is written to at least one additional data block at block 525. The flowchart 600 continues at block 630, where the project manifest 340 for the project instance 201 is modified to include a current version 341 that references the at least one additional data block. As shown at block 635, in some embodiments, modifying the project manifest 340 also includes storing a previous version 342 of the project instance 201.

In the one or more embodiments of FIG. 6, a determination is made at block 645 as to whether the number of versions referenced by the project manifest 340 of the project instance 201 exceeds the version limit identified at block 615. In response to a determination at block 645 that the number of versions referenced by the project manifest 340 of the project instance 201 exceeds the storage space limit, the project manifest 340 of the project instance 201 is modified at block 650 to no longer include an earlier version of the project instance 201.

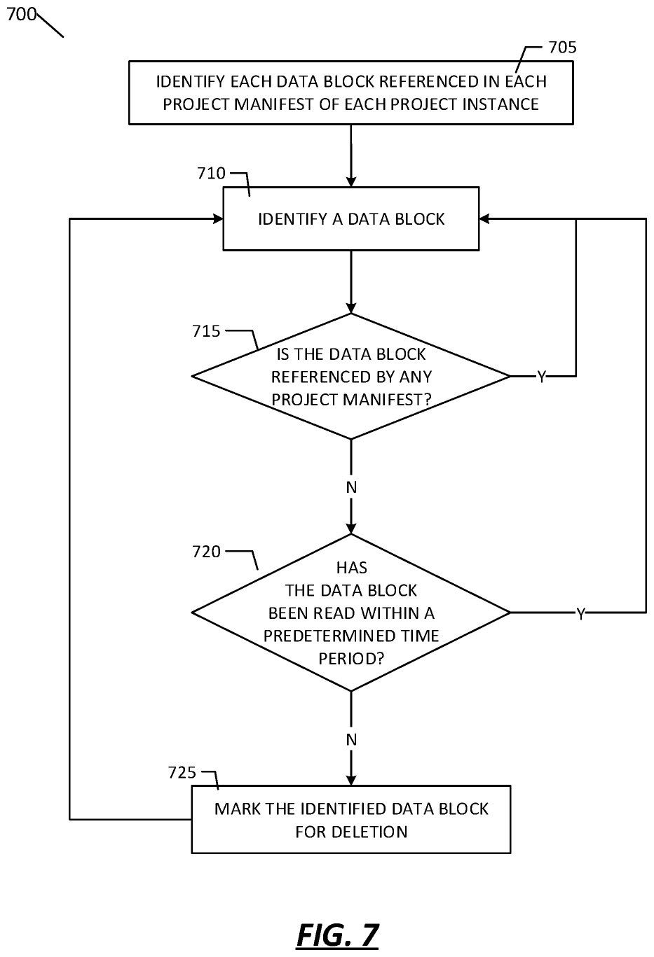

FIG. 7 shows a flowchart 700 of a technique for reducing storage space, according to one or more additional embodiments.

The flowchart 700 begins at block 705, where each data block referenced by each project manifest 340 is identified. The flowchart 700 continues at block 710, where a data block is identified. A determination is made at block 715 as to whether the identified data block is referenced by any project manifest 340 of any project instance 201. If a determination is made at block 715 that the identified data block is referenced by a project manifest 340 of at least one project instance 201, the flowchart 700 returns to block 710 and another data block is identified. Alternatively, if a determination is made at block 715 that the identified data block is not referenced by any project manifest 340 of any project instance 201, the identified data block may be marked as available for deletion at block 725. In some embodiments, a second determination may be made at block 720 as to whether the data block has been read by a project instance 201 within a predetermined time period (e.g., in the past 24 hours). In those embodiments, if a determination is made at block 720 that the data block has been read by a project instance 201 within the predetermined time period, the identified data block is not marked as available for deletion at block 725 and, instead, the flowchart 700 returns to block 710 and another data block is identified.

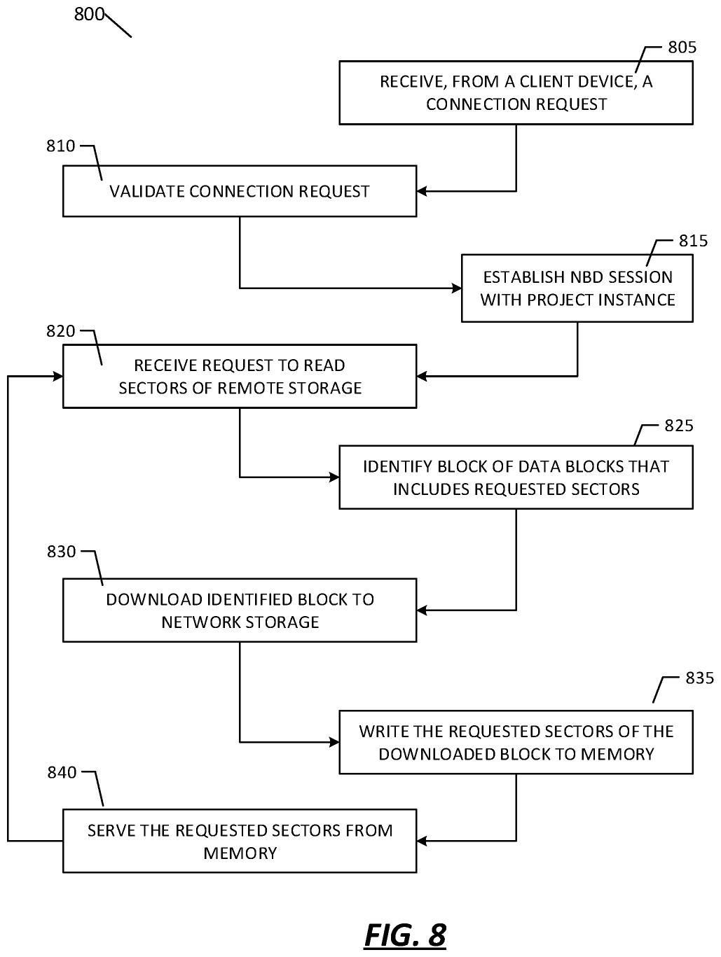

FIG. 8 shows a flowchart 800 of a technique for serving a project instance, according to one or more additional embodiments.

The flowchart 800 begins at block 805, where a connection request is received from a remote device 102. The flowchart 800 continues at block 810, where the connection request is validated, and at block 815, where a network block device (NBD) session is established with the project instance 201.

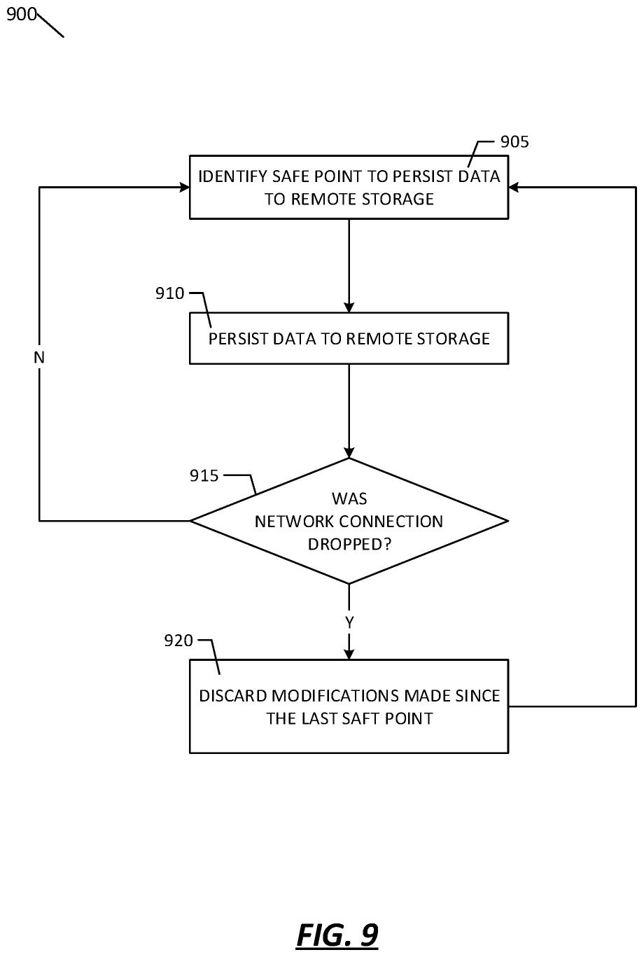

The flowchart 800 continues at block 820, where the network device 120 receives a request to read sectors of remote storage 146. As described above, the remote storage 146 may be partitioned into blocks 380 (e.g., 16 MiB blocks). At block 825, the block 380 that includes the requested sectors is identified. At block 830, the identified block 380 is downloaded to network storage 142 so that the requested sectors may be served by the network system 120. In some embodiments, the requested sectors of the downloaded block 380 may be written to memory in block 835 so that the requested sectors can be served from memory 144 at block 840. For instance, each 16 MiB block 380 may be partitioned into smaller blocks 382 (e.g., 512 KiB blocks) and the smaller block 382 that includes the requested sectors may be written to memory 144. As additional requests to read sectors from the remote storage 146 are received many of those sectors may have already been downloaded to network storage 142 or written to memory 144. Accordingly, unlike the prior art methods, the disclosed technique allows project instance data to be served from network storage 142 (or even from memory 144) without downloading data from network storage 142 in response to each request to read project instance data. Meanwhile, blocks 380 downloaded to remote storage 146 (or smaller blocks 382 written to memory 144) may be copy-on-write modified by the server and persisted to remote storage 146 later (for example, as described below with reference to FIG. 9). Accordingly, unlike the prior art methods, the disclosed technique allows project instance data to be updated without persisting that data to network storage 142 each time a project instance 201 is updated.

FIG. 9 shows a flowchart 900 of a technique for persisting a project instance to remote storage, according to one or more additional embodiments.

The flowchart 900 begins at block 905, where a safe point to persist data to remote storage is identified. In some embodiments, for example, a userspace block device driver may be used to detect safe points. In other embodiments, the system may detect safe point to persist data to remote storage by detecting when super blocks are updated.

The flowchart 900 continues at block 910, where data is persisted to remote storage 146. At block 915, a determination is made as to whether the network connection was dropped unexpectedly. If a determination is made at block 915 that the network connection was dropped, modifications made since the last safe point are discarded at block 920. Alternatively, if no determination is made at block 915 that the network connection was dropped, the flowchart 900 returns to block 905.

For each of FIGS. 4-9, it should be understood that the particular flow of the flow diagram is used only to exemplify one embodiment. In other embodiments, any of the various components depicted in the flow diagram may be omitted, or the components may be performed in a different order, or even concurrently. In addition, other embodiments may include additional steps not depicted as part of the flow diagram. Further, the various steps may be described as being performed by particular modules or components for purposes of explanation, but should not be considered limited to those components.

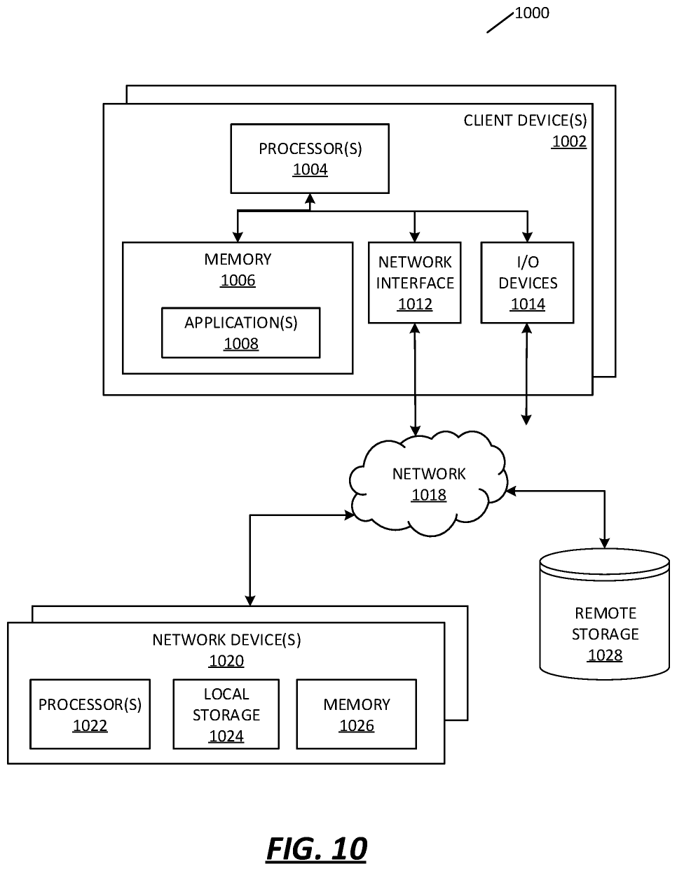

FIG. 10 shows an example of a hardware system for implementation of the storage management techniques in accordance with the disclosed embodiments. FIG. 10 depicts a network diagram 1000 including a client computing device 1002 connected to one or more network devices 1020 over a network 1018. Client device 1002 may comprise a personal computer, a tablet device, a smart phone, network device, or any other electronic device which may be used to perform debugging operations on a computer program. The network 1018 may comprise one or more wired or wireless networks, wide area networks, local area networks, enterprise networks, short range networks, and the like. The client computing device 1002 can communicate with the one or more network devices 1020 using various communication-based technologies, such as Wi-Fi, Bluetooth, cable connections, satellite, and the like. Users of the client devices 1002 can interact with the network devices 1020 to access services controlled and/or provided by the network devices 1020.

Client devices 1002 may include one or more processors 1004. Processor 104 may include multiple processors of the same or different type, and may be configured to execute computer code or computer instructions, for example computer readable code stored within memory 1006. For example, the one or more processors 1004 may include one or more of a central processing unit (CPU), graphics processing unit (GPU), or other specialized processing hardware. In addition, each of the one or more processors may include one or more processing cores. Client devices 1002 may also include a memory 1006. Memory 1006 may each include one or more different types of memory, which may be used for performing functions in conjunction with processor 1004. In addition, memory 1006 can include one or more of transitory and/or non-transitory computer readable media. For example, memory 106 may include cache, ROM, RAM, or any kind of computer readable storage device capable of storing computer readable code. Memory 106 may store various programming modules and applications 1008 for execution by processor 1004. Examples of memory 1006 include magnetic disks, optical media such as CD-ROMs and digital video disks (DVDs), or semiconductor memory devices.

Computing device 1002 also includes a network interface 1012 and I/O devices 1014. The network interface 1012 may be configured to allow data to be exchanged between computing devices 1002 and/or other devices coupled across the network 1018. The network interface 1012 may support communication via wired or wireless data networks. Input/output devices 1014 may include one or more display devices, keyboards, keypads, touchpads, mice, scanning devices, voice or optical recognition devices, or any other devices suitable for entering or retrieving data by one or more client devices 1002.

Network devices 1020 may include similar components and functionality as those described in client devices 1002. Network devices 1020 may include, for example, one or more servers, network storage devices, additional client devices, and the like. Specifically, network device may include one or more processors 1022, local storage 1024, memory 1026. The one or more processors 1022 can include, for example, one or more of a central processing unit (CPU), graphics processing unit (GPU), or other specialized processing hardware. In addition, each of the one or more processors 1022 may include one or more processing cores. In some embodiments, the one or more network devices 1020 may be connected to a remote storage device 1028 over a network 1018.

Each of local storage 1024, memory 1026, and remote storage 1028 may include one or more of transitory and/or non-transitory computer readable media, such as magnetic disks, optical media such as CD-ROMs and digital video disks (DVDs), or semiconductor memory devices. The remote storage 1028 may be provided by a cloud service, such as Google Cloud Platform (Google is a registered trademark of Google LLC), Amazon Web Services (Amazon Web Services is a registered trademark of Amazon Technologies, Inc.), etc. While the various components are presented in a particular configuration across the various systems, it should be understood that the various modules and components may be differently distributed across the network.

While preferred embodiments have been described above, those skilled in the art who have reviewed the present disclosure will readily appreciate that other embodiments can be realized within the scope of the invention. Accordingly, the present invention should be construed as limited only by any appended claims.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. A non-transitory computer readable medium comprising computer readable code executable by one or more processors to:
initiate, by an integrated development environment, a project instance comprising project data, the project data stored in a plurality of data blocks in cloud storage; and
generate a project manifest for the project instance comprising a reference to each of the plurality of data blocks storing the project data of the project instance;
wherein at least a portion of the data blocks are referenced in additional manifests for additional projects.

2. The non-transitory computer readable medium of claim 1, wherein:
initiating the project instance comprises forking a previously initiated project instance;
the previously initiated project instance has a project manifest referencing a current version of the previously initiated project instance; and
generating the project manifest for the initiated project instance comprising copying the current version of the project manifest for the previously initiated project instance.

3. The non-transitory computer readable medium of claim 1, further comprising computer readable code to modify project data stored in an initial set of data blocks by:
performing a copy-on-write process to write the modified project data to an additional set of data blocks; and
updating the project manifest to reference the additional set of data blocks.

4. The non-transitory computer readable medium of claim 3, wherein:
the project manifest includes a current version of the project instance; and
updating the project manifest to reference the additional set of data blocks comprises updating the current version to reference the additional set of data blocks.

5. The non-transitory computer readable medium of claim 3, wherein modifying the project data stored in the initial set of data blocks further comprises updating the project manifest to include a historic version of the project instance referencing the initial set of data blocks.

6. The non-transitory computer readable medium of claim 5, further comprising computer readable code to:
storing the data blocks referenced by at least one historic version of the project manifest for retrieval for a predefined time period; and
in response to a request for a historic version within the predefined time period, providing a read-only version of the data blocks referenced by the requested historic version.

7. The non-transitory computer readable medium of claim 3, wherein the integrated development environment provides functionality to initiate a plurality of project instances, further comprising computer readable code to:
determine whether the initial data block is referenced by any project manifest of any of the plurality of project instances; and
making the initial data block available for deletion in response to a determination that the initial data block is not referenced by any of the project manifests.

8. The non-transitory computer readable medium of claim 7, wherein the initial data block is made available for deletion further in response to a determination that the initial data block has not been accessed within a predetermined time period.

9. A method, comprising:
initiating, by an integrated development environment, a project instance comprising project data, the project data stored in a plurality of data blocks in cloud storage; and
generating a project manifest for the project instance comprising a reference to each of the plurality of data blocks storing the project data of the project instance;
wherein at least a portion of the data blocks are referenced in additional manifests for additional projects.

10. The method of claim 9, wherein:
initiating the project instance comprises forking a previously initiated project instance;
the previously initiated project instance has a project manifest referencing a current version of the previously initiated project instance; and
generating the project manifest for the initiated project instance comprises copying the current version of the project manifest for the previously initiated project instance.

11. The method of claim 9, further comprising modifying project data stored in an initial set of data blocks by:
performing a copy-on-write process to write the modified project data to an additional set of data blocks; and
updating the project manifest to reference the additional set of data blocks.

12. The method of claim 11, wherein:
the project manifest includes a current version of the project instance; and
updating the project manifest to reference the additional set of data blocks comprises updating the current version to reference the additional set of data blocks.

13. The method of claim 11, wherein modifying the project data stored in the initial set of data blocks further comprises updating the project manifest to include a historic version of the project instance referencing the initial set of data blocks.

14. The method of claim 13, further comprising:
storing the data blocks referenced by at least one historic version of the project manifest for retrieval for a predefined time period; and
in response to a request for a historic version within the predefined time period, providing a read-only version of the data blocks referenced by the requested historic version.

15. The method of claim 11, wherein the integrated development environment provides functionality to initiate a plurality of project instances, the method further comprising:
determining whether the initial data block is referenced by any project manifest of any of the plurality of project instances; and
making the initial data block available for deletion in response to a determination that the initial data block is not referenced by any of the project manifests.

16. The method of claim 15, wherein the initial data block is made available for deletion further in response to a determination that the initial data block has not been accessed within a predetermined time period.

17. A system, comprising:
network storage; and
one or more servers configured to:
provide an integrated development environment;
initiate a project instance comprising project data, the project data stored in a plurality of data blocks in cloud storage; and
generate a project manifest for the project instance comprising a reference to each of the plurality of data blocks storing the project data of the project instance;
wherein at least a portion of the data blocks are referenced in additional manifests for additional projects.

18. The system of claim 17, wherein the one or more servers are configured to:
initiating the project instance by forking a previously initiated project instance having a project manifest referencing a current version of the previously initiated project instance; and
generate the project manifest for the initiated project instance by copying the current version of the project manifest for the previously initiated project instance.

19. The server of claim 17, wherein the one or more servers are configured to modify project data stored in an initial set of data blocks by:
performing a copy-on-write process to write the modified project data to an additional set of data blocks; and
updating the project manifest to reference the additional set of data blocks.
